(19) United States
(12) Patent Application Publication
(10) Pub. No.: US 2026/0361822 A1
(43) Pub. Date: Nov. 12, 2026

(54) IMAGE FORMING DEVICE AND IMAGE FORMING METHOD

(71) Applicant: Yuta Nojiro, Mishima Shizuoka (JP)

(72) Inventor: Yuta Nojiro, Mishima Shizuoka (JP)

(73) Assignee: ETRIA Co., Ltd., Kanagawa (JP)

(21) Appl. No.: 19/449,274

(22) Filed: Jan. 14, 2026

(30) Foreign Application Priority Data
May 7, 2025 (JP) 2025-077138

(51) Int. Cl. H04N 1/00; H04N 1/32

(52) U.S. Cl. CPC H04N 1/00342; H04N 1/32138

(57) ABSTRACT

According to one aspect of the present invention, there is an image forming device including a tag communication unit configured to write data to a plurality of wireless tags on a wireless tag sheet with the plurality of wireless tags by communicating with the wireless tags, an image forming unit configured to form an image on a sheet on which the image is to be formed, and a visualization unit configured to visualize a wireless tag with which a communication failure has occurred among the plurality of wireless tags.

### CROSS-REFERENCE TO RELATED APPLICATION

This application is based upon and claims the benefit of priority from Japanese Patent Application No. 2025-077138, filed May 7, 2025, the entire content of which is incorporated herein by reference.

### FIELD

An embodiment of the present invention relates to an image forming device and an image forming method.

### BACKGROUND

There is an image forming device that can simultaneously write information to a radio frequency identification (RFID) tag (hereinafter referred to as a wireless tag) and form an image on a sheet for dedicated paper (hereinafter referred to as a sheet) with an RFID tag. For such an image forming device, there has been a conventional technology that allows, when a communication failure with a wireless tag has been occurred, a user to visually identify a sheet on which the communication failure has occurred.

However, when a plurality of wireless tags are provided on a single sheet, in the conventional technology, it may not be possible to identify which of the plurality of wireless tags has experienced a communication failure.

### BRIEF DESCRIPTION OF THE DRAWINGS

FIG. 1 is a diagram which shows an example of a configuration of an image forming device 1 according to the present embodiment.

FIG. 2 is a diagram which shows an example of a hardware configuration of the image forming device 1 according to the present embodiment.

FIG. 3 is a diagram which shows an example of sheet information.

FIG. 4 is a flowchart (part 1) which shows an example of a flow of first image forming processing and second image forming processing performed by the image forming device 1 of the embodiment.

FIG. 5 is a flowchart (part 2) which shows an example of the flow of the first image forming processing and second image forming processing performed by the image forming device 1 of the embodiment.

FIG. 6 is a diagram which shows an example of processing by which the image forming device 1 manages a completion status of communication with wireless tags of a target sheet.

FIG. 7 is an example of a sheet S1 on which second wireless tag information has been printed by the first image forming processing.

FIG. 8 is a diagram which shows an example of processing by which the image forming device 1 causes the display unit 18 to display a message indicating that all jobs have been completed.

FIG. 9 is a diagram which shows an example of processing by which the image forming device 1 causes the display unit 18 to display a message indicating that communication with all the wireless tags of the target sheet has failed.

FIG. 10 is a diagram which shows an example of a target sheet and a normal sheet that have been bound.

### DETAILED DESCRIPTION

An image forming device according to an embodiment includes a tag communication unit configured to write data to a plurality of wireless tags on a wireless tag sheet with the plurality of wireless tags by communicating with the wireless tags, an image forming unit configured to form an image on a sheet on which the image is to be formed, and a visualization unit configured to visualize a wireless tag with which a communication failure has occurred among the plurality of wireless tags.

When a sheet with a plurality of wireless tags is processed, the image forming device according to an embodiment can make it possible to identify whether a communication failure has occurred for each of the plurality of wireless tags.

The image forming device according to an embodiment will be described below with reference to the drawings.

As used throughout this disclosure, the singular forms “a,” “an,” and “the” include plural references unless the context clearly dictates otherwise.

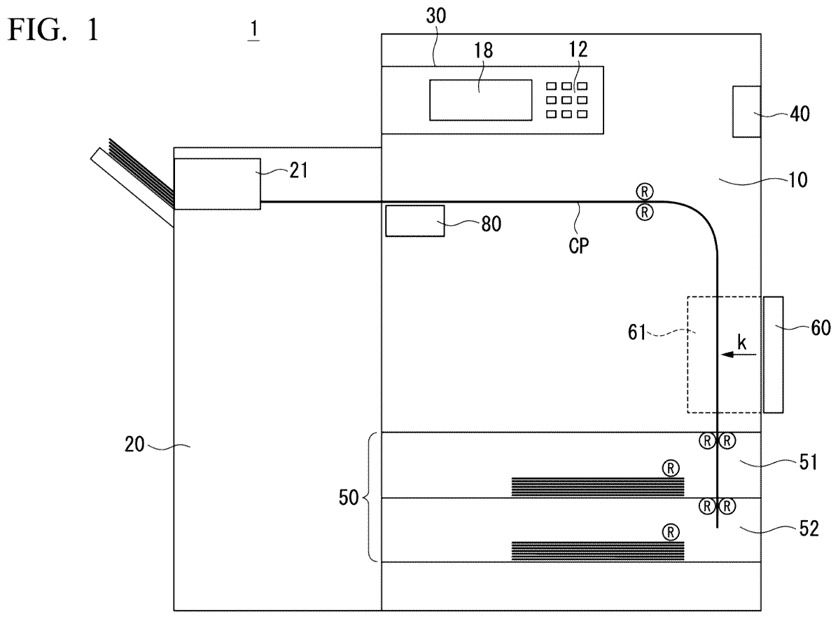

FIG. 1 shows an example of a configuration of an image forming device 1 according to the present embodiment. For example, the image forming device 1 may be disposed in a workplace. Hereinafter, a medium on which the image forming device 1 forms an image is referred to as a “sheet.” The sheet is typically a paper medium, but any medium of a material and a shape that can be subjected to image forming processing may be used. The image forming device 1 includes, for example, a main body device 10 and a sheet processing device 20.

The main body device 10 forms an image on a sheet to be processed. The main body device 10 performs first image forming processing on a sheet with a wireless tag (hereinafter referred to as a “wireless tag sheet”) and performs second image forming processing on a sheet without a wireless tag (hereinafter referred to as a “normal sheet”). The main body device 10 writes data to a wireless tag on the wireless tag sheet and performs the first image forming processing on the wireless tag sheet to which the data has been successfully written. The main body device 10 performs second image forming processing on the normal sheet for the wireless tag to which the data has been successfully written. The sheet processing device 20 performs finishing processing on a sheet transported from the main body device 10. The sheet processing device 20 of the present embodiment can perform finishing processing, including at least sheet binding processing.

The main body device 10 includes a control panel 30, an external communication unit 40, a paper-feeding unit 50, a wireless tag communication unit 60, an image forming unit 70, a sheet detection unit 80, a storage unit 93, and a control unit 100.

The control panel 30 includes an input unit 12 and a display unit 18. For example, the input unit 12 receives an input from a user. For example, the display unit 18 is a touch panel. The display unit 18 receives an input from a user and displays it to the user. For example, the control panel 30 displays setting items related to an operation of the image forming device 1 on the display unit 18. The control panel 30 notifies the control unit 100 of items set by the user.

The external communication unit 40 is a communication interface that allows the image forming device 1 to communicate with other devices. The external communication unit 40 may be a unit for wired communication or a unit for wireless communication. For example, the image forming device 1 communicates with a user terminal via the external communication unit 40 to receive a request for image forming processing of a sheet from a user terminal.

The control unit 100 controls the control panel 30, the wireless tag communication unit 60, the image forming unit 70, and the sheet processing device 20. The control unit 100 controls transport of a sheet in the image forming unit 70. Controlling the transport of a sheet means adjusting a transport timing of the sheet, a stopping position of the sheet, a transport speed of the sheet, and the like by controlling each roller R provided on a transport path CP.

The paper-feeding unit 50 stores wireless tag sheets and normal sheets. The sheets are made of materials such as paper or plastic film. The paper-feeding unit 50 includes a first paper-feeding unit 51 that stores wireless tag sheets and a second paper-feeding unit 52 that stores normal sheets.

The image forming unit 70 performs an operation of forming an image. For example, the image forming unit 70 forms an image represented by image data on a sheet. In the following description, forming an image on a sheet is also referred to as “printing.” In the present embodiment, the image forming unit 70 is a device for fixing a toner image, but the present invention is not limited to this, and it may also be an inkjet device.

The wireless tag communication unit 60 includes a calculation device, a storage device, and an antenna. The wireless tag in the present embodiment is, for example, a radio frequency identifier (RFID) tag. The wireless tag communication unit 60 transmits radio waves in a direction of an arrow k, for example. The wireless tag communication unit 60 communicates with wireless tags provided on the wireless tag sheet via an antenna. For example, the wireless tag communication unit 60 can wirelessly communicate with wireless tags on a wireless tag sheet that has been temporarily stopped at a predetermined position by a registration roller. Specifically, the wireless tag communication unit 60 reads information from the wireless tags and writes information to the wireless tags. The predetermined position is a position where the wireless tag on the wireless tag sheet is stopped so that it falls within a detection range 61.

Information written to the wireless tag includes an identification number of a sheet, and the like. For example, when the sheet is used for logistics, information indicating contents, information indicating a destination, content to be printed on the sheet, and the like may be written to the wireless tag. In the present embodiment, the wireless tag communication unit 60 uses, for example, a 900 MHz radio wave system (UHF). However, the RFID system and frequency band are not limited to this, and other systems and frequency bands may also be employed.

The sheet detection unit 80 is a sensor for detecting whether a sheet is being transported at a specific position on the transport path CP.

The control unit 100 controls each unit of the image forming device 1. The wireless tag communication unit 60 may be configured separately from the image forming device 1, as shown in FIG. 1, or may be configured as an integrated part of the image forming device 1.

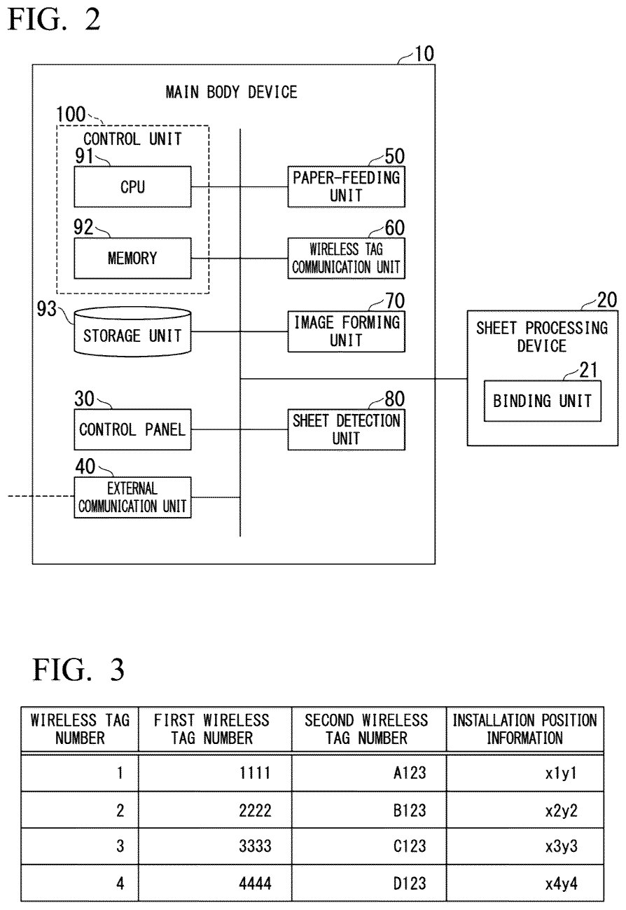

FIG. 2 shows an example of a hardware configuration of the image forming device 1 of the present embodiment. The image forming device 1 includes a central processing unit (CPU) 91, a memory 92, a storage unit 93, and the like connected via a bus, and executes a program. By executing the program, the main body device 10 functions as a device including the control panel 30, the external communication unit 40, the paper-feeding unit 50, the wireless tag communication unit 60, the image forming unit 70, the sheet detection unit 80, and the control unit 100.

The CPU 91 functions as the control unit 100 by executing the program stored in the memory 92 and the storage unit 93. The control unit 100 controls operations of each functional unit of the main body device 10 and the sheet processing device 20.

The storage unit 93 is configured using a storage device such as a magnetic hard disk drive or semiconductor storage device. The storage unit 93 is used as a storage region for information related to the image forming device 1. The storage unit 93 stores, for example, setting information related to the first image forming processing and the second image forming processing (hereinafter referred to as “sheet information”), information related to a communication status with a wireless tag, and the like. Sheet information includes, for example, information on image formation on the wireless tag sheet and information to be written to the wireless tag on the wireless tag sheet.

The external communication unit 40 is a communication interface for connecting the image forming device 1 to a communication network. The external communication unit 40 may be a wireless communication interface or a wired communication interface. The external communication unit 40 may be a LAN interface or a cellular communication interface. The image forming device 1 can communicate with other devices via the external communication unit 40.

The sheet processing device 20 includes a binding unit 21. The binding unit 21 performs processing (binding processing) for binding sheets transported from the main body device 10 into groups of a predetermined number of sheets. For example, the binding unit 21 may be a stapling device or a device that folds a predetermined number of sheets together. The sheet processing device 20 performs the binding processing under conditions instructed by the control unit 100 of the main body device 10.

FIG. 3 shows an example of sheet information. FIG. 3 shows sheet information TB1 as an example of sheet information. For example, the sheet information is registered in the storage unit 93 as a table TB1, which has four records for each wireless tag number. Each record has values for a wireless tag number, first wireless tag information, second wireless tag information, and installation position information. The wireless tag number is an identification number of four wireless tags. Here, assuming that four wireless tags are provided on a single sheet, the four wireless tags are identified by numbers 1, 2, 3, and 4.

The first wireless tag information is used in image forming processing (second image forming processing) for wireless tags that, for some reason, have not successfully completed wireless communication with the image forming device 1. On the other hand, the second wireless tag information is used for writing to wireless tags that have successfully completed wireless communication with the image forming device 1. Installation position information indicates an installation position of each wireless tag within the sheet. The first wireless tag information, the second wireless tag information, and the installation position information have different values registered for each wireless tag within the same sheet.

The sheet information is registered in the storage unit 93 before the image forming device 1 performs image forming processing on the wireless tag sheet. The sheet information may be input to the image forming device 1 by the user operating the input unit 12, or may be input to the image forming device 1 from another device (for example, the user's PC) via the external communication unit 40.

For the sake of simplicity, the following describes a case in which one wireless tag sheet has four wireless tags, as in the example of FIG. 3. However, content of the present embodiment can be applied to cases in which the number of wireless tags per sheet is other than four by appropriately interpreting the number of wireless tags per sheet and items determined accordingly.

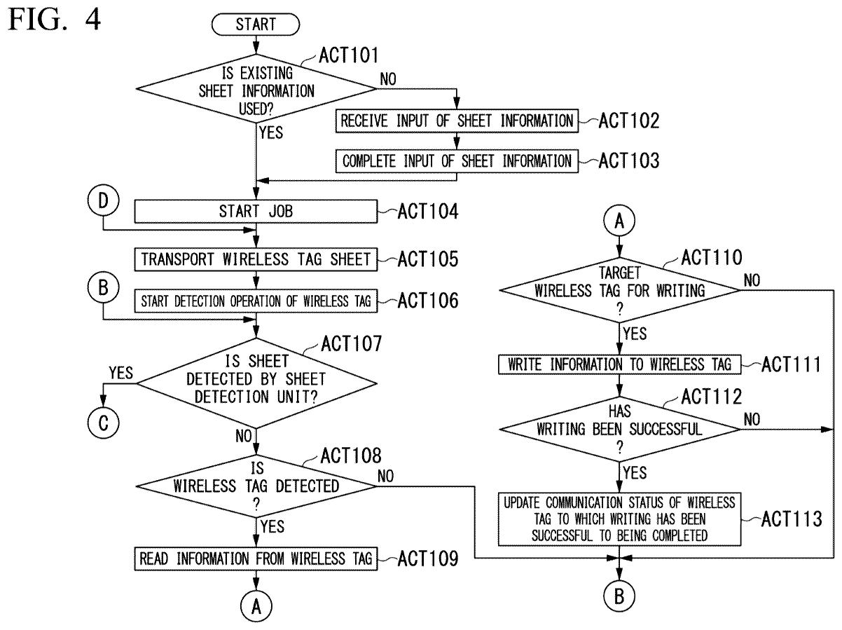

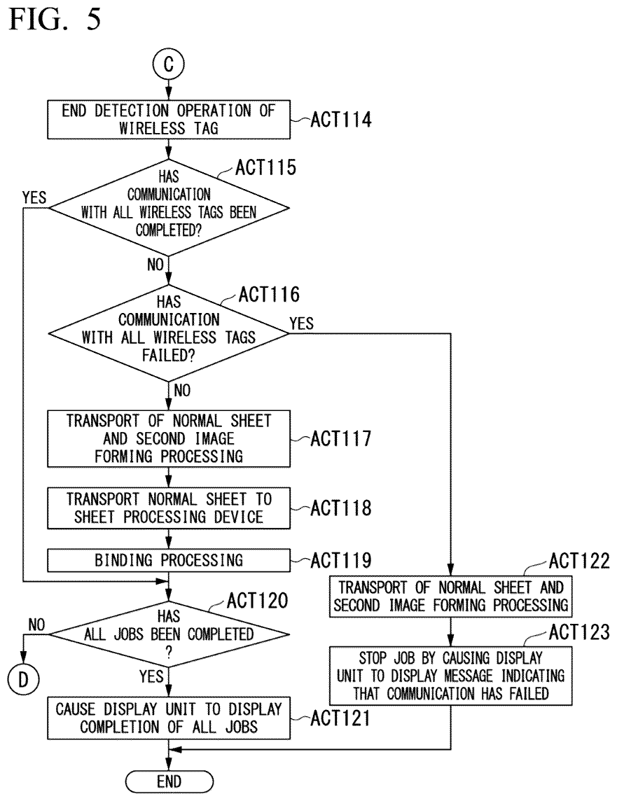

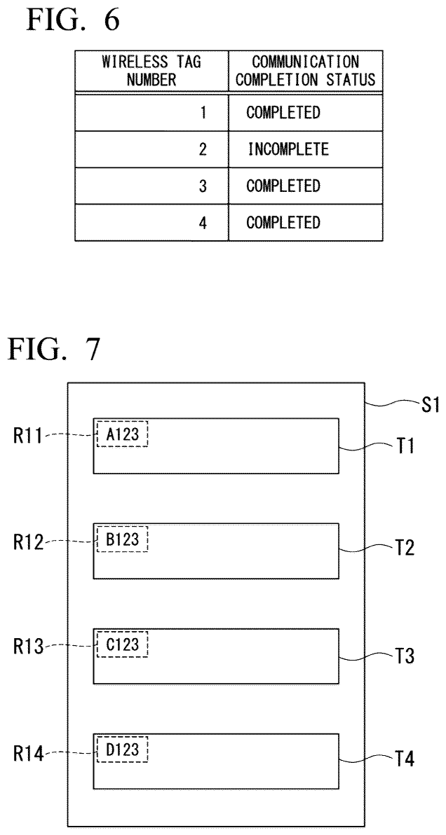

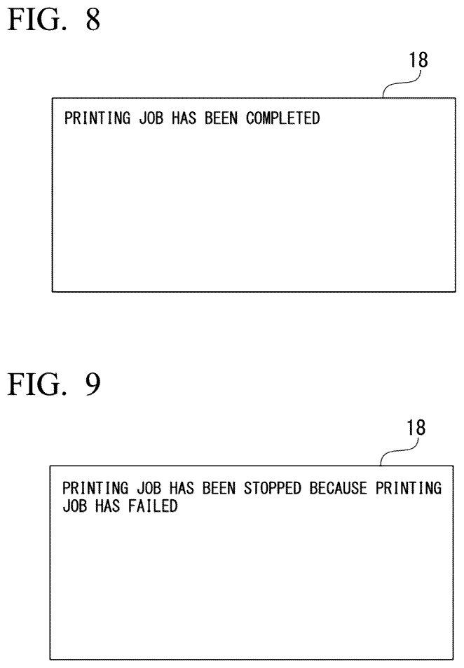

FIGS. 4 and 5 are flowcharts which show an example of a flow of the first image forming processing and the second image forming processing performed by the image forming device 1 of the embodiment. First, the user inputs a new job of the first image forming processing into the image forming device 1. At this time, the image forming device 1 receives a selection operation of whether to use pre-registered sheet information or to input new sheet information (ACT 101).

When it is selected to input new sheet information in ACT 101, the image forming device 1 receives an input of sheet information (ACT 102) and stores the input sheet information in the storage unit 93 to complete the input of sheet information (ACT 103).

On the other hand, when it is selected to use pre-registered sheet information in ACT 101, the image forming device 1 starts a new job on the basis of the registered sheet information (ACT 104). Here, when there is a plurality of pieces of registered sheet information, the image forming device 1 may allow the user to select one of the pieces of sheet information.

Next, the image forming device 1 feeds a wireless tag sheet from the paper-feeding unit 50 and transports it to a vicinity of the wireless tag communication unit 60 (ACT 105). Hereinafter, the wireless tag sheet fed here is referred to as a target sheet. When transport of the target sheet is started in ACT 105, the wireless tag communication unit 60 starts a detection operation of a wireless tag (ACT 106). The image forming device 1 determines whether the target sheet has been detected by the sheet detection unit 80 (ACT 107), and when it determines that the target sheet has not been detected, it continues the detection of a wireless tag and determines whether a wireless tag has been detected within the detection range 61 (ACT 108). Here, when it determines that a wireless tag has been detected, the image forming device 1 reads information from the detected wireless tag (ACT 109), and determines based on the read information whether the wireless tag is a target wireless tag for writing (ACT 110).

The image forming device 1 manages a completion status (completed or incomplete) of communication with itself for the four wireless tags of the target sheet. In this case, the image forming device 1 first identifies an installation position of the read wireless tag by searching the sheet information based on the information read in ACT 109. Next, the image forming device 1 checks the communication completion status of the identified wireless tag, determines that the wireless tag is a target for writing if the communication is incomplete, and determines that the wireless tag is not a target for writing if the communication is complete.

When the image forming device 1 determines in ACT 110 that the wireless tag is a target for writing, it writes information to the target wireless tag for writing (ACT 111). The wireless tag has a wireless tag number stored in advance, and the image forming device 1 can identify information to be written by searching for sheet information based on the wireless tag number read in ACT 109. For example, in the example of FIG. 3, when a wireless tag number 1 is read, the image forming device 1 identifies corresponding second wireless tag information “A123” as the information to be written.

Next, the image forming device 1 determines whether the writing in ACT 111 has been successful (ACT 112), and when it determines that the writing has been successful, it updates the communication completion status of the wireless tag to which the writing has been successful to “being completed” (ACT 113). For example, the image forming device 1 reads information from the wireless tag to which the information has been written. It determines that the writing has been successful when the read information matches second wireless tag information in the sheet information, and when they do not match, it determines that the writing has failed.

On the other hand, when it determines in ACT 108 that a wireless tag has not been detected, when it determines in ACT 110 that the wireless tag is not a target for writing, or when it determines in ACT 112 that the writing has failed, the image forming device 1 proceeds to processing in ACT 107, and repeatedly executes the processing of detecting the target wireless tag for writing and the writing processing until the target sheet is detected by the sheet detection unit 80.

On the other hand, when it determines in ACT 107 that the target sheet is detected by the sheet detection unit 80, the image forming device 1 ends the detection operation of a wireless tag (ACT 114) and executes the first image forming processing indicating that communication with the wireless tag has been successful in an area on the target sheet, corresponding to the installation position of the wireless tag with which communication has been successful. FIG. 7 shows an example of a sheet S1 on which second wireless tag information is printed by the first image forming processing. The example in FIG. 7 represents an example in which second wireless tag information of corresponding wireless tags is printed in regions R11 to R14 on the target sheet S1, corresponding to the four wireless tags T1 to T4. The image forming device 1 transports the target sheet on which the first image forming processing is performed, to the sheet processing device 20.

Next, the image forming device 1 determines whether communication has been successful (whether writing has been successful) for all wireless tags on the target sheet (ACT 115). When it determines that communication has been successful for all wireless tags on the target sheet, the image forming device 1 determines whether all jobs have been completed (ACT 120). When it determines that an uncompleted job remains, the image forming device 1 proceeds to processing in ACT 105 and executes a next job.

On the other hand, when it determines in ACT 120 that all jobs have been completed, the image forming device 1 causes the display unit 18 to display a message indicating that all jobs have been completed (ACT 121), and ends the flowchart.

On the other hand, when it determines in ACT 115 that communication has failed with some of the wireless tags of the target sheet, the image forming device 1 determines whether communication has failed with all of the wireless tags of the target sheet (ACT 116). Here, when it determines that communication has failed with all of the wireless tags of the target sheet, the image forming device 1 transports a normal sheet, performs second image forming processing indicating that communication has failed with all of the wireless tags of the target sheet (ACT 122), causes the display unit 18 to display this message (ACT 123), and ends the flowchart.

As is clearly known from the flowchart, in this case, the flowchart will end regardless of whether there are any uncompleted jobs. In other words, when there are any uncompleted jobs in this case, those jobs are stopped.

On the other hand, when it is determined in ACT 116 that communication was successful with some of the wireless tags on the target sheet, the image forming device 1 transports the normal sheet and performs second image forming processing on an area on the normal sheet corresponding to an installation position of a wireless tag with which communication has failed, indicating that communication with the wireless tag at that installation position has failed (ACT 117). The image forming device 1 transports the normal sheet on which the second image forming processing has been performed in ACT 117 to the sheet processing device 20 (ACT 118)

Next, the sheet processing device 20 performs binding processing on a set of the target sheet transported after ACT 114 and the normal sheet transported in ACT 118 (ACT 119). The image forming device 1 proceeds to processing in ACT 120, and when there are any uncompleted jobs, proceeds to processing in ACT 107. When all jobs have been completed, the image forming device displays this message (ACT 121), and ends the flowchart.

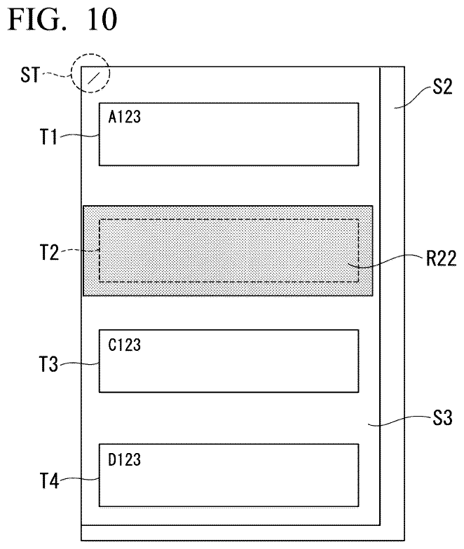

FIG. 10 shows an example of target sheets and normal sheets that have been bound. FIG. 10 shows an example of a case where a communication failure has occurred with a wireless tag T2 on a target sheet S2. In this case, after the first image forming processing for wireless tags T1, T3, and T4 with which communication has been successful is performed on the target sheet S2, the second image forming processing is performed on a region R22 corresponding to the wireless tag T2 with which communication failed on the normal sheet S3. After the first image forming processing and the second image forming processing end, the target sheet S2 and the normal sheet S3 are sent to the sheet processing device 20 and subjected to binding processing, respectively.

Hereinafter, several examples of operational results that can occur in the flowcharts of FIGS. 4 and 5 will be described.

### FIRST EXAMPLE

In a first example, the following job flow is assumed.
(1) A wireless tag sheet (target sheet) was fed from the paper-feeding unit 50 (ACT 104).
(2) The wireless tag communication unit 60 completed communication with all wireless tags disposed on the target sheet (ACT 108).
(3) The image forming unit 70 performed the first image forming processing on all wireless tags on the target sheet and transported the target sheet to the sheet processing device 20 (ACT 114 to ACT 115).

In this case, the processing proceeds to ACT 115—YES, and since transport of a normal sheet is not performed, binding processing by the sheet processing device 20 is not performed in this job.

### SECOND EXAMPLE

In a second example, the following job flow is assumed.
(1) A wireless tag sheet (target sheet) was fed from the paper-feeding unit 50 (ACT 104).
(2) The wireless tag communication unit 60 did not complete communication with one wireless tag out of the four wireless tags disposed on the target sheet, but completed communication with the other three wireless tags (ACT 108).
(3) The image forming unit 70 performed the first image forming processing on the three wireless tags with which communication was completed (ACT 114 to ACT 115), and transported a normal sheet and performed the second image forming processing on the wireless tag with which communication was not completed (ACT 117).

In this case, the target sheet on which the first image forming processing was performed and the normal sheet on which the second image forming processing was performed are transported to the sheet processing device 20, and the binding processing by the sheet processing device 20 is performed in this job.

### THIRD EXAMPLE

In a third example, the following job flow is assumed.
(1) A wireless tag sheet (target sheet) was fed from the paper-feeding unit 50 (ACT 104).
(2) The wireless tag communication unit 60 did not complete communication with all four wireless tags disposed on the target sheet (ACT 108).
(3) The image forming unit 70 did not perform the first image forming processing on the target sheet, transports a normal sheet, and performs the second image forming processing on the four wireless tags with which communication was not completed (ACT 117).

In this case, since communication was not completed with all four wireless tags placed on the target sheet, the image forming device 1 stops the job (ACT 123 to end).

### FOURTH EXAMPLE

In a fourth example, the following job flow is assumed.
(1) Transport of a wireless tag sheet and/or a normal sheet is completed, and a current job ends (ACT 115—YES, ACT 119). (2) There are jobs remaining to be executed (ACT 120).

In this case, the image forming device 1 transports a new wireless tag sheet and executes the remaining jobs (ACT 120—NO).

### FIFTH EXAMPLE

In a fifth example, the following job flow is assumed.
(1) Transport of a wireless tag sheet and/or a normal sheet is completed, and a current job ends (ACT 115—YES, ACT 119).
(2) There are no jobs remaining to be executed (ACT 120).

In this case, the image forming device 1 displays a message indicating that all jobs have been completed (ACT 121) and ends the flowchart.

According to at least one of the embodiments described above, when a sheet having a plurality of wireless tags is processed, it is possible to identify whether there is a communication failure with the plurality of wireless tags for each wireless tag. By ejecting only the target sheet, the user can recognize that communication with all wireless tags on the target sheet has been completed. By ejecting a normal sheet along with the target sheet, the user can recognize that communication with one or more wireless tags on the target sheet has not been completed. By stopping the job for the target sheet, the user can recognize that communication with all wireless tags on the target sheet has not been completed.

When a normal sheet is ejected, the user can also recognize that the job has been stopped or that communication with some wireless tags has not been completed, based on content of an image formed on the normal sheet. When a normal sheet is ejected, the user can recognize that the job has been stopped or that communication with some wireless tags has been incomplete, based on display content on the display unit 18. This configuration makes it possible to visually determine results of communication processing with a plurality of wireless tags attached to a single wireless tag sheet.

Several embodiments of the present invention have been described, but these embodiments are presented as examples and are not intended to limit the scope of the invention. These embodiments may be implemented in a variety of other forms, and various omissions, substitutions, and modifications may be made within a range not departing from the gist of the invention. These embodiments and their modifications are included within the scope and gist of the invention, as well as within the scope of the claims and their equivalents.

What is claimed is:

1. An image forming device comprising:
a tag communication unit configured to write data to a plurality of wireless tags on a wireless tag sheet with the plurality of wireless tags by communicating with the wireless tags;
an image forming unit configured to form an image on a sheet on which the image is to be formed; and
a visualization unit configured to visualize a wireless tag with which a communication failure has occurred among the plurality of wireless tags.

2. The image forming device according to claim 1,
wherein the visualization unit forms an image of a wireless tag with which the communication failure has occurred in a visualization medium separate from the wireless tag sheet.

3. The image forming device according to claim 1, further comprising:
a binding unit configured to bind the wireless tag sheet and a medium in which a wireless tag with which the communication failure has occurred is visualized on the wireless tag sheet.

4. The image forming device according to claim 3,
wherein the image forming unit performs first image forming processing on a wireless tag sheet having one or more wireless tags with which communication has been successful, and performs second image forming processing on a normal sheet having no wireless tags as the medium, visualizing a wireless tag with which a communication failure has occurred.

5. The image forming device according to claim 4,
wherein the binding unit binds the wireless tag sheet that has been subjected to the first image forming processing and the normal sheet that has been subjected to the second image forming processing.

6. The image forming device according to claim 4,
wherein the image forming unit performs the first image forming processing on a position on the wireless tag sheet corresponding to an installation position of a wireless tag with which communication has been successful on the wireless tag sheet, and performs the second image forming processing on a position on the normal sheet corresponding to an installation position of a wireless tag with which a communication failure has occurred on the wireless tag sheet.

7. The image forming device according to claim 1,
wherein the image forming unit stops an image forming operation when a communication failure occurs in all wireless tags included in a single wireless tag sheet.

8. The image forming device according to claim 7,
wherein the image forming unit performs first image forming processing on the wireless tag sheet and second image forming processing on a normal sheet that does not have the wireless tag.

9. The image forming device according to claim 8,
wherein the image forming unit performs the second image forming processing and stops the image forming operation when a communication failure has occurred in all wireless tags included in a single wireless tag sheet.

10. The image forming device according to claim 1, further comprising:
a sheet detection unit configured to detect a sheet sent along a transport path before the image forming unit,
wherein the tag communication unit communicates with the wireless tag from a start of sheet transport to the sheet being detected by the sheet detection unit.

11. An image forming method comprising:
by an image forming device,
writing data to a plurality of wireless tags by a tag communication unit communicating with the wireless tags on a wireless tag sheet having the plurality of wireless tags;
forming, by an image forming unit, an image on a sheet on which the image is to be formed; and
visualizing, by a visualization unit, a wireless tag with which a communication failure has occurred among the wireless tags.

12. The image forming method according to claim 11,
wherein the visualization unit forms an image of the wireless tag with which the communication failure has occurred on a visualization medium separate from the wireless tag sheet.

13. The image forming method according to claim 11, further comprising:
binding, by a binding unit, the wireless tag sheet and a medium in which the wireless tag with which the communication failure has occurred is visualized on the wireless tag sheet.

14. The image forming method according to claim 13,
wherein the image forming unit performs first image forming processing on a wireless tag sheet having one or more wireless tags with which communication has been successful, and performs second image forming processing on a normal sheet having no wireless tags as the medium, visualizing a wireless tag with which a communication failure has occurred on the normal sheet.

15. The image forming method according to claim 14,
wherein the binding comprises binding the wireless tag sheet on which the first image forming processing has been performed and the normal sheet on which the second image forming processing has been performed.

16. The image forming method according to claim 14,
wherein the image forming unit performs the first image forming processing on a position on the wireless tag sheet corresponding to an installation position on the wireless tag sheet of a wireless tag with which communication has been successful, and performs the second image forming processing on a position on the normal sheet corresponding to an installation position on the wireless tag sheet of a wireless tag with which a communication failure has occurred.

17. The image forming method according to claim 11,
wherein the image forming unit stops an image forming operation when a communication failure has occurred in all wireless tags included in a single wireless tag sheet.

18. The image forming method according to claim 17,
wherein the image forming unit performs the first image forming processing on the wireless tag sheet, and performs the second image forming processing on a normal sheet that does not have the wireless tag.

19. The image forming method according to claim 18,
wherein the image forming unit performs the second image forming processing and stops the image forming operation when a communication failure has occurred in all wireless tags included in a single wireless tag sheet.

20. The image forming method according to claim 11, further comprising:
detecting, by a sheet detection unit, a sheet sent along a transport path before the image forming unit,
wherein the tag communication unit communicates with the wireless tag from a start of sheet transport to the sheet being detected by the sheet detection unit.
